(19) United States
(12) Patent Application Publication
(10) Pub. No.: US 2013/0214521 A1
(43) Pub. Date: Aug. 22, 2013

(54) Fender Assembly For Off-Highway Machine

(71) Applicants: Jonathan Seger, Aurora, IL (US); Phillip Hartz, Naperville, IL (US)

(72) Inventors: Jonathan Seger, Aurora, IL (US); Phillip Hartz, Naperville, IL (US)

(73) Assignee: CATERPILLAR, INC., Peoria, IL (US)

(21) Appl. No.: 13/398,920

(22) Filed: Feb. 17, 2012

(51) Int. Cl. B62D 25/18

(52) U.S. Cl. 280/851

(57) ABSTRACT

A fender assembly for an off-highway machine includes a metallic fender, and a non-metallic fender extension having a one-piece shell. The one-piece shell includes an interior surface defining a cavity, a shell wall extending throughout the one-piece shell, and a plurality of elongate reinforcement pockets formed by intrusions of the shell wall into the cavity.

### TECHNICAL FIELD

The present disclosure relates generally to a fender assembly for an off-highway machine, and relates more particularly to a fender extension including a one-piece shell having a plurality of elongate reinforcement pockets.

### BACKGROUND

Fenders are used on all manner of vehicles to block the spray of water and debris from a rotating wheel. A typical fender includes one or more formed pieces of sheet metal coupled to a body of the associated vehicle, and forming a wheel well which receives a ground engaging wheel. Many different fender designs, having both ornamental and utilitarian functions, have been proposed over the years.

Depending upon the intended service environment of the vehicle, manufacturability, cost and aesthetic concerns, fenders may obscure relatively more or relatively less of the associated wheel. In certain designs, the actual fender extends about less than 50%, and commonly less than 25%, of the outer wheel circumference, and a fender extension is attached to the fender to provide additional water and debris blocking functionality. Due to the harsh operating environment of off-highway vehicles, including the likelihood of flying rock, mud, etc., striking a wheel facing surface of the fender extension, such components typically need to be made fairly robust.

In the context of on-highway vehicles such as certain trucks, flaps and the like for blocking spray are commonly attached to the vehicle body by way of downwardly hanging brackets, whether an actual fender is used or not. One example of such a flap is known from UK Patent Application GB 2,157,243A, proposing a vehicle mud flap molded with an integral flange serving as a mounting bracket. The flange can apparently be folded out of a plane to produce a three dimensional configuration enabling direct mounting onto a vehicle wheel arch. While the disclosed design may provide improvement over conventional mounting strategies in on-highway machines, it is likely not sufficiently rugged for off-highway applications, and not compatible with certain off-highway vehicle designs.

### SUMMARY

In one aspect, an off-highway machine includes a frame, a ground engaging wheel defining a wheel axis and being rotatably coupled to the frame, and a fender assembly coupled to the frame. The fender assembly includes a metallic fender, and an attached non-metallic fender extension projecting from the fender about the wheel axis. The fender extension includes a one-piece shell having an exterior surface, an interior surface defining a cavity, and a shell wall extending throughout the one-piece shell. The one-piece shell further includes a plurality of elongate reinforcement pockets each formed by an intrusion of the shell wall into the cavity and opening toward the ground engaging wheel.

In another aspect, a fender assembly for an off-highway machine includes a metallic fender including a wheel facing side having an arcuate surface defining a wheel well configured to receive a ground engaging wheel of the off-highway machine, and a second side opposite the wheel facing side and having a platform surface positionable adjacent to an operator cab of the off-highway machine. The fender assembly further includes a non-metallic fender extension attached to the fender adjacent to the platform surface and projecting from the fender about the wheel well. The fender extension includes a one-piece shell having an exterior surface, an interior surface defining a cavity, and a shell wall extending throughout the one-piece shell. The one-piece shell further includes a plurality of elongate reinforcement pockets each being formed by an intrusion of the shell wall into the cavity and opening toward the wheel well.

In still another aspect, a non-metallic fender extension attachable to a metallic fender defining a wheel well, for forming a fender assembly in an off-highway machine, includes a one-piece shell including an exterior surface having an upper side, and a lower side positionable in facing relation to the wheel well. The one-piece shell further includes an interior surface defining a cavity, and a shell wall extending throughout the one-piece shell. The one-piece shell further includes a front edge configured to abut the fender, a back edge and a length extending between the front and back edges. The one-piece shell further includes a width which is greater than the length, and a height extending between the upper and lower sides which is less than each of the length and the width. The one-piece shell further includes a plurality of reinforcement pockets elongated in a front to back direction, each of the plurality of reinforcement pockets being formed by an intrusion of the shell wall into the cavity, and extending inwardly from the lower side. The upper side of the one-piece shell is convex, and the lower side is concave and parallel to the upper side, such that the fender extension has a curved profile made congruent with the wheel well upon forming the fender assembly.

### BRIEF DESCRIPTION OF THE DRAWINGS

FIG. 1 is a pictorial view of an off-highway machine having a fender assembly, according to one embodiment;

FIG. 2 is an enlarged view of a portion of the off-highway machine of FIG. 1, including the fender assembly;

FIG. 3 is a bottom view of a portion of the fender assembly of FIGS. 1 and 2;

FIG. 4 is a bottom view of a fender extension, suitable for use in the fender assembly of FIGS. 1-3;

FIG. 5 is a pictorial view of the fender extension of FIG. 4;

FIG. 6 is a front view of the fender extension of FIGS. 4 and 5;

FIG. 7 is a sectioned view taken along line 7-7 of FIG. 5;

FIG. 8 is a sectioned view taken along line 8-8 of FIG. 7; and

FIG. 9 is a sectioned view taken along line 9-9 of FIG. 7.

### DETAILED DESCRIPTION

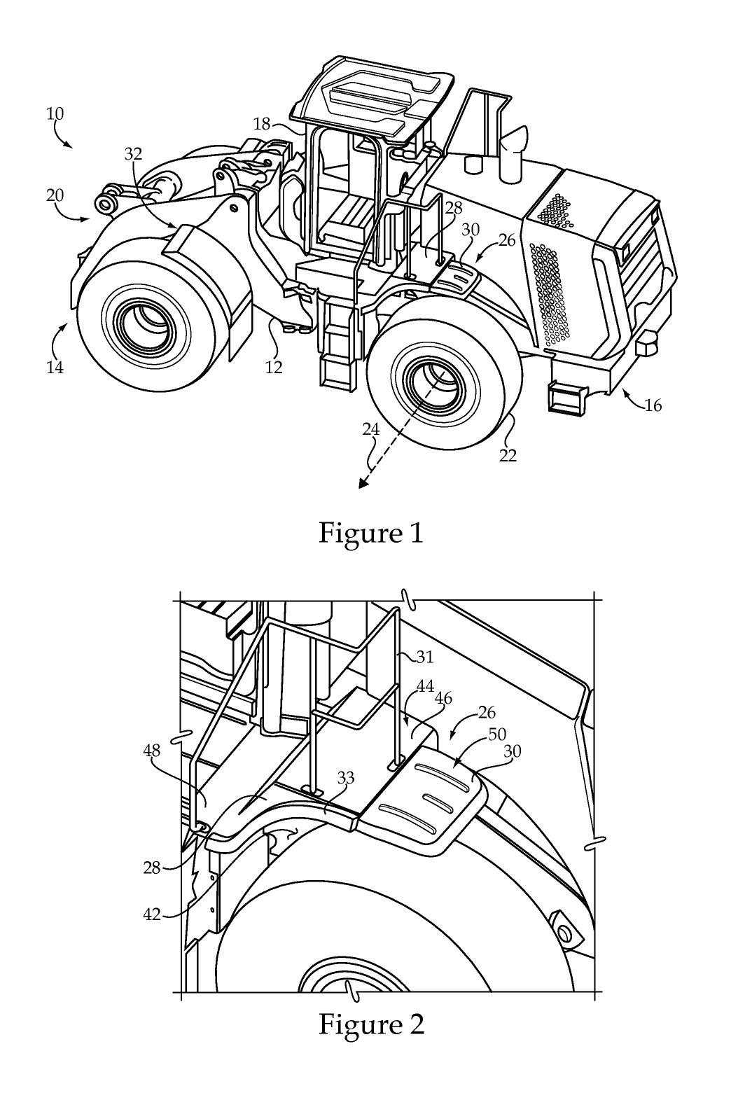

Referring to FIG. 1, there is shown an off-highway machine 10 according to one embodiment. Machine 10 includes a frame 12 having a front frame end 14, a back frame end 16, and an operator cab 18 mounted upon frame 12. An implement system 20 is positioned forwardly of cab 18 and may include a hydraulically actuated implement system configured for use with a bucket, blade, fork, or variety of other implements in a conventional manner. A plurality of ground engaging wheels 22 are rotatably coupled to frame 12, and each define a wheel axis, one of which is shown and identified via reference numeral 24. Machine 10 may further include a plurality of back fender assemblies 26, one of which is visible in FIG. 1, coupled to frame 12, and a plurality of front fender assemblies 32 also coupled to frame 12. Each back fender assembly 26 includes a metallic fender 28 and an attached non-metallic fender extension 30 projecting from fender 28 about wheel axis 24. Machine 10 is shown in the context of a wheel loader, however, alternative machine configurations are contemplated herein and machine 10 might instead comprise a wheel tractor, a truck, or any of a variety of other off-highway machines benefiting from the use of fender assemblies.

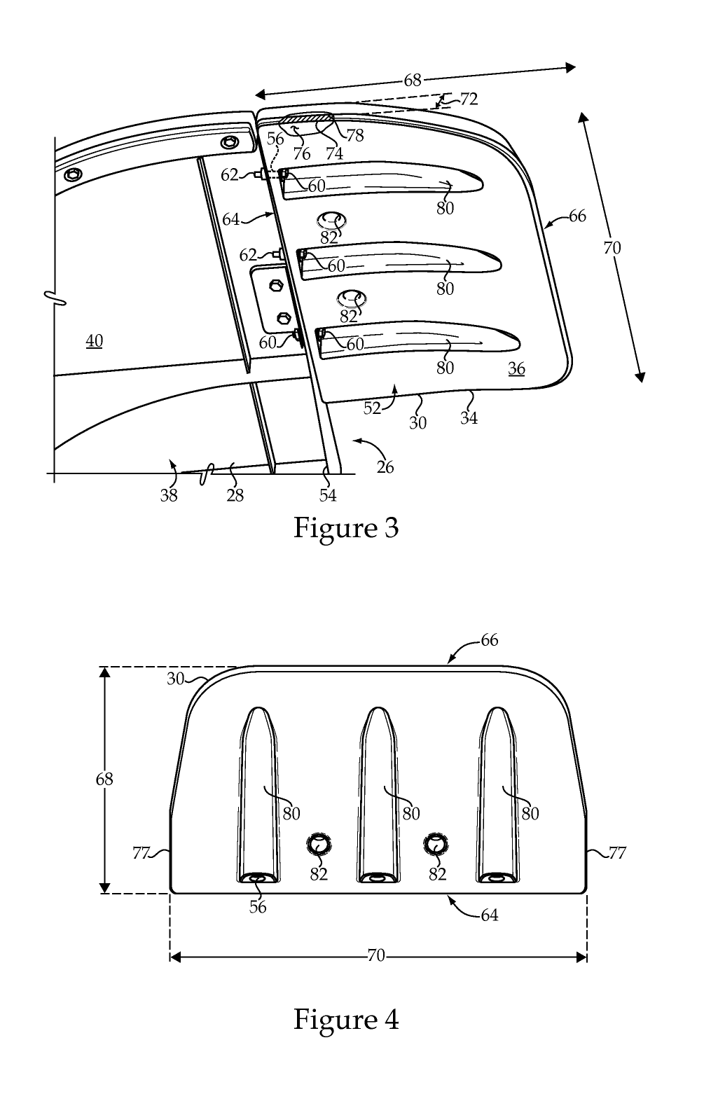

Referring now also to FIGS. 2 and 3, there are illustrated additional details of fender assembly 26. Fender 28 may include a wheel facing side 38 having an arcuate surface 40 defining a wheel well 42 configured to receive a ground engaging wheel 22 of machine 10. Fender 28 further includes a second side 44 opposite wheel facing side 38 and having a platform surface 46 positionable adjacent to operator cab 18. In one embodiment, platform surface 46 may include a planar back platform surface located at a higher elevation, and second side 44 of fender 28 may further include a planar front platform surface 48 located at a lower elevation. Front and back platform surfaces 46 and 48 may be oriented parallel one another such that fender 28 has a stepped profile. A railing 31 may be mounted to fender 28 in a conventional manner.

Fender extension 30 may include a one-piece shell 34 having an exterior surface 36, an interior surface 74 defining a cavity 76, and a shell wall 78 extending throughout one-piece shell 34. FIG. 3 is shown in partial cutaway illustrating shell wall 78 and a part of cavity 76, details of each of which are further discussed below. Shell 34 may further include a front edge 64 abutting fender 28, an opposite back edge 66, and a length 68 extending from front edge 64 to back edge 66. Shell 34 may further include a width 70 greater than length 68, and a height 72 less than each of length 68 and width 70. It may be noted from FIG. 3 that width 70 decreases in a front to back direction such that shell 34 has a tapered shape. Fender 28 may also include a transverse flange 54 positioned adjacent to back platform surface 46, and shell 34 defines a plurality of through-holes 56. Fender assembly 26 may further include a plurality of fasteners 60 extending through/received within the plurality of through-holes and through-transverse flange 54 to attach fender extension 30 to fender 28. A plurality of nuts 62 which may include welded-on nuts attached to fender 28 may be coupled with fasteners 60.

It may be noted from FIGS. 1-3 that fender extension 30 has a curved profile, in other words a shape of extension 30 is curved when viewing extension 30 from the side. Exterior surface 36 may include a concave upper side 50 transitioning with platform surface 46, and a convex lower side 52 which is parallel to upper side 50, imparting the curved profile. Lower side 52 is positionable in facing relation to wheel well 42. Shell 34 may further include a plurality of reinforcement pockets 80 elongated in a front to back direction. Each of pockets 80 may be formed by an intrusion of shell wall 78 into cavity 76, and extends inwardly from lower side 52. In a practical implementation strategy, through-holes 56 communicate between front edge 64 and pockets 80, such that one of through-holes 56 opens within each of pockets 80. It may thus be appreciated that pockets 80 serve multiple purposes, including reinforcing fender extension 30, and providing access to fasteners 60/through-holes 56 for attaching extension 30 to fender 28 to form fender assembly 26.

Referring now also to FIG. 4, there is shown a bottom view of fender extension 30. It will be recalled that elongate reinforcement pockets 80 are formed by intrusions of shell wall 78 into cavity 76. Shell wall 78 may also include a plurality of stiffening columns 82, also formed by intrusions of shell wall 78 into cavity 76. In a practical implementation strategy, a total of two stiffening columns 82 are provided, and a total of three reinforcement pockets 80. Reinforcement pockets 80 may narrow in a front to back direction, and in particular also decreasing in height in the front to back direction, and thus having a talon shape. Stiffening columns 82 may narrow in an upward direction and each have a frustoconical shape, which will be further apparent in subsequently described illustrations. As noted above, width 70 may also decrease in the front to back direction, and may be initially uniform as defined by parallel forward sections of outboard edges 77 of shell 34, and then narrowing as defined by angled back sections of outboard edges 77.

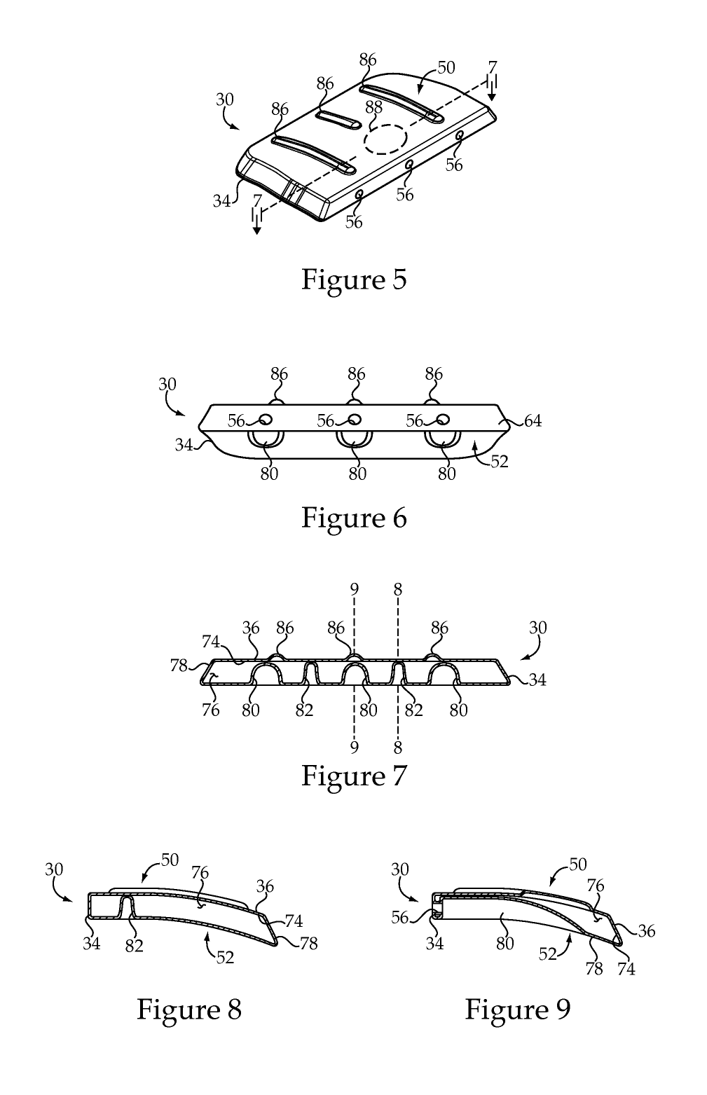

Referring now to FIG. 5, there is shown another view of fender extension 30, and in particular illustrating a plurality of elongate reinforcement protrusions 86 extending outwardly from upper side 50. In the illustrated embodiment, a center one of protrusions 86 is relatively short, whereas outer ones of protrusions 86 are relatively long. A marking 88 may be positioned forwardly of the center protrusion 86, having the form of an embossed or indented, molded-in “no step” safety warning or the like. Through-holes 56 are shown opening at front edge 64 in FIG. 5. Referring also to FIG. 6, there is shown a front view of shell 34, and illustrating front edge 64 edge-on. It may be noted from FIG. 6 that protrusions 86, and in particular the outer ones thereof, are arranged in an offset pattern with pockets 80. In other words, a longitudinal centerline of each of the outer ones of protrusions 86 is not vertically aligned with a longitudinal centerline of pockets 80, but is instead offset. By way of comparison, the center protrusion 86 may not be offset from the corresponding opposite center one of pockets 80. Referring also to FIG. 7, there is shown a sectioned view taken along line 7-7 of FIG. 5. It may be noted from FIG. 7 that stiffening columns 82 extend inwardly from lower side 52, and in particular span cavity 76. It may further be noted that stiffening columns 82 may be understood to be arranged in an alternating pattern with pockets 80, and may also be understood to be arranged in an alternating pattern with protrusions 86. Stiffening columns 82 may have the form of kiss connectors in one embodiment, such that inner surface 74 may be understood to contact itself at the interface of stiffening columns 82 with an opposite part of shell 34. As noted above, shell wall 78 extends throughout shell 34. This may be understood to mean that shell wall resides at substantially every location within shell 34. Still another way to understand this feature is that one would be unable to touch fender extension 30, and in particular shell 34, without touching shell wall 78. It will be recalled that pockets 80 are formed by intrusions of shell wall 34 into cavity 76. Stiffening columns 82 may be similarly formed, but instead of merely intruding into cavity 76, they vertically span cavity 76.

Referring also now to FIGS. 8 and 9, there are shown sectioned views taken along lines 8-8 and 9-9 of FIG. 7, respectively. Considering FIG. 8 and FIG. 7 together, the frustoconical shape of reinforcement protrusions 82 is readily apparent. FIG. 9 shows the longitudinal profile formed by pockets 80, as well as the curved longitudinal profile of shell 34 itself. When attached to fender 28 to form fender assembly 26, extension 30 may curve about wheel well 42. In other words, the curved profile is made congruent with wheel well 42 upon forming fender assembly 26. It will be recalled that extension 30 projects from fender 28 about wheel axis 24 as shown in FIG. 1. Extension 30 may further be understood to include a horizontal footprint, and may be positioned over ground engaging wheel 14 such that wheel axis 24 is positioned within the horizontal footprint. The orientation and position in space of extension 30 may further be understood by way of comparing fender assembly 26 with front fender assembly 32 shown in FIG. 1. Due to its position upon machine 10, front fender assembly 32 would not be understood to include a horizontal footprint within which a corresponding wheel axis is positioned.

In one practical implementation strategy, shell 34 may be formed from any of a variety of suitable non-metallic materials, including polypropylene. Insofar as manufacturing techniques are concerned, shell 34 may be formed by rotary molding in certain embodiments. Those skilled in the pertinent mechanical arts will be familiar with rotary molding, in which a powdered mold material may be introduced into a multi-piece mold tool, which is then heated and spun to enable the material to distribute itself within the mold cavity. Rotary molding provides one practical way to achieve a relatively uniform construction of shell 34, such as a construction in which shell wall 78 has a uniform thickness everywhere. In certain embodiments, the uniform thickness of shell 34 between exterior surface 36 and interior surface 74 may be about 5 mm, or less. The uniform thickness of shell wall 78 throughout shell 34 will be readily apparent in view of the various sectioned views discussed herein.

### INDUSTRIAL APPLICABILITY

Those skilled in the art will be familiar with the desirability of economizing on machine parts, and in particular avoiding unnecessary duplication of part numbers. Fender extension 30 may be left to right symmetrical, such that identical fender extensions may be used on both the left and right sides of the associated machine. Fender extension 30 may also be formed from relatively lightweight, but strong materials, and constructed such that a shape of fender extension 30 imparts rigidity and overall structural strength not possible or at least impractical without certain specialized features such as pockets 80. In the course of designing extension 30, it was discovered that pockets 80 having the elongated shapes shown provide a practical way to impart strength to shell 34 without complicating manufacturing or requiring additional structural support components. Protrusions 86 serve an analogous structural role. Stiffening columns 82 enhance structural integrity by spanning cavity 76, and also impart advantageous vibrational properties to extension 30.

Those skilled in the art will also be familiar with the harsh operating conditions many off-highway machines and their components are subjected to. In the case of wheel loaders, it is common for mud or other debris to be thrown off from a spinning wheel and impact the fender or fender extension with significant force. Various of the features of extension 30 disclosed herein provide for robust design, and tolerance of debris strikes, without resulting in a fender extension which is unduly heavy. As alluded to above, other properties relating to the overall structural integrity and robustness of extension 30 are vibrational in nature. Fender extensions contemplated herein may have a first resonance mode greater than 20 hz, considered suitable for certain off-highway machines such as medium sized wheel loaders, although the present disclosure is not thereby limited.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. An off-highway machine comprising:
a frame;
a ground engaging wheel defining a wheel axis and being rotatably coupled to the frame; and
a fender assembly coupled to the frame and including a metallic fender, and an attached non-metallic fender extension projecting from the fender about the wheel axis;
the fender extension including a one-piece shell having an exterior surface, an interior surface defining a cavity, and a shell wall extending throughout the one-piece shell; and
the one-piece shell further having a plurality of elongate reinforcement pockets each formed by an intrusion of the shell wall into the cavity and opening toward the ground engaging wheel.

2. The machine of claim 1 wherein the fender extension includes a horizontal footprint and is positioned over the ground engaging wheel such that the wheel axis is positioned within the horizontal footprint.

3. The machine of claim 2 wherein the one-piece shell defines a plurality of through-holes each opening within one of the pockets, and the fender assembly further includes a plurality of fasteners extending through the plurality of through-holes and attaching the fender extension to the fender.

4. The machine of claim 2 wherein the fender further includes a planar platform surface, and the exterior surface of the shell includes a concave upper side transitioning with the planar platform surface, and a convex lower side.

5. The machine of claim 5 wherein the shell wall forms a plurality of stiffening columns vertically spanning the cavity and arranged in an alternating pattern with the plurality of elongate reinforcements.

6. The machine of claim 5 wherein the shell wall includes a uniform thickness throughout the one-piece shell.

7. A fender assembly for an off-highway machine comprising:
a metallic fender including a wheel facing side having an arcuate surface defining a wheel well configured to receive a ground engaging wheel of the off-highway machine, and a second side opposite the wheel facing side and having a platform surface positionable adjacent to an operator cab of the off-highway machine;
a non-metallic fender extension attached to the fender adjacent to the platform surface and projecting from the fender about the wheel well; and
the fender extension including a one-piece shell having an exterior surface, an interior surface defining a cavity, and a shell wall extending throughout the one-piece shell, the one-piece shell further including a plurality of elongate reinforcement pockets each being formed by an intrusion of the shell wall into the cavity and opening toward the wheel well.

8. The fender assembly of claim 7 wherein:
the platform surface includes a planar back platform surface located at a higher elevation, and the second side of the fender further includes a planar front platform surface located at a lower elevation and oriented parallel to the back platform surface such that the fender has a stepped profile; and
the exterior surface of the one-piece shell includes a concave upper side transitioning with the back platform surface, and a convex lower side parallel to the concave upper side, such that the fender extension has a curved profile.

9. The fender assembly of claim 8 wherein the fender further includes a transverse flange positioned adjacent to the back platform surface, and wherein the one-piece shell defines a plurality of through-holes each opening within one of the reinforcement pockets, and the fender assembly further includes a plurality of fasteners extending through the plurality of through-holes and the transverse flange to attach the fender extension to the fender.

10. The fender assembly of claim 8 wherein the one-piece shell includes a front edge abutting the fender, a back edge, and a length extending from the front edge to the back edge, and the one-piece shell further including a width greater than the length, and a height less than each of the length and the width.

11. The fender assembly of claim 10 wherein the width decreases in a front to back direction such that the one-piece shell has a tapered shape.

12. The fender assembly of claim 8 wherein the shell wall forms a plurality of stiffening columns vertically spanning the cavity.

13. The fender assembly of claim 12 wherein the plurality of stiffening columns include a plurality of kiss connectors extending inwardly from the lower side and arranged in an alternating pattern with the plurality of elongate reinforcement pockets.

14. The fender assembly of claim 13 further comprising a plurality of elongate reinforcement protrusions extending outwardly from the upper side and arranged in an offset pattern with the plurality of reinforcement pockets and the plurality of kiss connectors.

15. A non-metallic fender extension attachable to a metallic fender defining a wheel well, for forming a fender assembly in an off-highway machine, the fender extension comprising:
a one-piece shell including an exterior surface having an upper side, a lower side positionable in facing relation to the wheel well, an interior surface defining a cavity, and a shell wall extending throughout the one-piece shell;
the one-piece shell further including a front edge configured to abut the fender, a back edge, and a length extending between the front and back edges, the one-piece shell further having a width which is greater than the length, and a height extending between the upper and lower sides which is less than each of the length and the width;
the one-piece shell further including a plurality of reinforcement pockets elongated in a front to back direction, each of the plurality of reinforcement pockets being formed by an intrusion of the shell wall into the cavity, and extending inwardly from the lower side; and
the upper side of the one-piece shell being convex, and the lower side being concave and parallel to the upper side, such that the fender extension has a curved profile made congruent with the wheel well upon forming the fender assembly.

16. The fender extension of claim 15 wherein the one-piece shell further defines a plurality of through-holes each communicating between the front edge and one of the plurality of reinforcement pockets, and being configured to receive a plurality of fasteners for attaching the fender extension to the fender to form the fender assembly.

17. The fender extension of claim 16 wherein the shell wall forms a plurality of stiffening columns vertically spanning the cavity, and includes a uniform thickness throughout the one-piece shell.

18. The fender extension of claim 17 wherein the plurality of stiffening columns includes a plurality of kiss connectors extending inwardly from the lower side and arranged in an alternating pattern with the plurality of elongate reinforcement pockets.

19. The fender extension of claim 18 further comprising a plurality of elongate reinforcement protrusions extending outwardly from the upper side and arranged in an offset pattern with the plurality of reinforcement pockets and the plurality of stiffening columns.

20. The fender extension of claim 19 wherein the plurality of reinforcement pockets includes a total of three reinforcement pockets each narrowing in the front to back direction and having a talon shape, and wherein the plurality of stiffening columns includes a total of two stiffening columns narrowing in an upward direction and each having a frustoconical shape.
